(19) United States
(12) Patent Application Publication
(10) Pub. No.: US 2011/0095623 A1
(43) Pub. Date: Apr. 28, 2011

(54) BATTERY PACK PROTECTION CIRCUIT, BATTERY PACK PROTECTION METHOD, AND ELECTRIC BICYCLE

(75) Inventors: Whan-Seok Doh, Yongin-si (KR); Sang-Won Lee, Yongin-si (KR)

(73) Assignee: Samsung SDI Co., Ltd., Yongin-si (KR)

(21) Appl. No.: 12/872,955

(22) Filed: Aug. 31, 2010

(30) Foreign Application Priority Data
Oct. 26, 2009 (KR) 10-2009-0101726

(51) Int. Cl. H01H 35/02

(52) U.S. Cl. 307/119

(57) ABSTRACT

A battery pack protection circuit includes: a sensing unit for sensing a variation in an angle of orientation; a charge/discharge control unit for outputting a stop control signal for interrupting charge and discharge operations of a battery cell, if the angle of orientation is greater than or equal to a reference angle of orientation; and a charge/discharge switch for stopping the charge and discharge operations of the battery cell in response to the stop control signal.

### RELATED APPLICATIONS

This application claims the benefit of Korean Patent Application No. 10-2009-0101726, filed on Oct. 26, 2009, in the Korean Intellectual Property Office, the disclosure of which is incorporated herein in its entirety by reference.

### BACKGROUND

1. Field

The present disclosure relates to a battery pack protection circuit, a method of protecting a battery pack, and an electric bicycle, and more particularly, to controlling charge and discharge operations of a battery pack according to an angle of orientation of an electric bicycle.

2. Description of the Related Technology

Due to developments in portable electronic devices such as cellular phones, laptop computers, camcorders, and personal digital assistants (PDAs), research into rechargeable batteries has been extensively conducted. Diverse types of rechargeable secondary batteries, including nickel-cadmium batteries, lead storage batteries, nickel metal hydride batteries (NiMH), lithium-ion batteries, lithium polymer batteries, metal lithium batteries, and air-zinc batteries, have been developed. Such a secondary battery arranged with a circuit may constitute a battery pack, and is charged or discharged via an external terminal of the battery pack.

Conventional battery packs typically include a battery cell and a peripheral circuit including a charge/discharge circuit. The peripheral circuit may be manufactured on a printed circuit board (PCB) and then connected to the battery cell. When such a battery pack is connected to an external power source via an external terminal of the battery pack, the battery cell may be charged by the external power source via the charge/discharge circuit. In addition, when a load is connected to the battery pack via the external terminal, the battery cell may supply power to the load via the charge/discharge circuit and the external terminal. In this regard, the charge/discharge circuit can control charge and discharge operations of the battery cell in between the external terminal and the battery cell.

Electric bicycles using a secondary battery have been widely used. Electric bicycles may use electrical energy to generate dynamic force to reduce a user's burden. Such electric bicycles have also drawn attention as environmentally friendly vehicles.

### SUMMARY

One or more embodiments of the present invention relate to improving safety of a battery pack by controlling charge and discharge operations of the battery pack according to an angle of orientation of the battery pack, or according to an angle of orientation of an electric bicycle mounted with the battery pack.

Additional aspects will be set forth in part in the description which follows and, in part, will be apparent from the description, or may be learned by practice of the presented embodiments.

According to one or more embodiments of the present invention, a battery pack protection circuit includes: a sensing unit for sensing a variation in the angle of orientation; a charge control unit for outputting a stop control signal for interrupting charge and discharge operations of a battery cell, if the angle of orientation is greater than or equal to a reference angle of orientation; and a charge/discharge switch for stopping the charge and discharge operations of the battery cell in response to the stop control signal.

The charge/discharge control unit may output a recovery control signal for resuming the charge and discharge operations of the battery cell to the charge/discharge switch when the angle of orientation becomes less than the reference angle of orientation after the stop control signal is output, and the charge/discharge switch may resume the charge and discharge operations of the battery cell in response to the recovery control signal.

The charge/discharge control unit may output the stop control signal only when the angle of orientation has been maintained greater than or equal to the reference angle of orientation for a first reference time duration or longer.

The charge/discharge control unit may output a recovery control signal for resuming the charge and discharge operations of the battery cell to the charge/discharge switch when the angle of orientation becomes less than the reference angle of orientation within a second reference time duration from when the stop control signal is output, and the charge/discharge switch may resume the charge and discharge operations of the battery cell in response to the recovery control signal.

The battery pack protection circuit may further include an adjusting unit for adjusting the reference angle of orientation according to a user's input. The battery pack protection circuit may be used in a battery pack for an electric bicycle, wherein the battery pack protection circuit further includes a driving control unit for outputting a drive control signal for stopping operation of wheels of the electric bicycle after the recovery control signal has been output.

According to one or more embodiments of the present invention, a battery pack protection method includes: sensing a tilt; determining whether the tilt is greater than or equal to a reference tilt; and interrupting charge and discharge operations of a battery cell if the tilt is greater than or equal to a reference tilt.

The battery pack protection method may further include resuming the charge and discharge operations of the battery cell if the tilt becomes less than the reference tilt after a stop control signal is output.

The interrupting of the charge and discharge operation may be performed only when the tilt has been maintained greater than or equal to the reference tilt for a first reference time duration or longer. The battery pack protection method may further include determining whether the tilt becomes less than the reference tilt within a second reference time duration from when the stop control signal is output, wherein the resuming of the charge and discharge operations of the battery cell is performed only when the tilt becomes less than the reference tilt within the second reference time duration from when the stop control signal is output.

The battery pack protection method may further include adjusting the reference tilt according to a user's input. The battery pack protection method may be used in a battery pack for an electric bicycle, wherein the method further includes interrupting operation of wheels of the electric bicycle after a recovery control signal is output.

According to one or more embodiments of the present invention, an electric bicycle on which a battery pack is mountable includes a sensing unit for sensing a tilt of the electric bicycle and interrupting the charge and discharge operations of the battery pack if the tilt is greater than or equal to a reference tilt. The sensing unit may resume the charge and discharge operations of the battery pack if the tilt becomes less than the reference tilt after the charge and discharge operations of the battery pack are interrupted.

The sensing unit may interrupt the charge and discharge operations of the battery pack only when the tilt has been maintained greater than or equal to the reference tilt for a first reference time duration or longer. The sensing unit may resume the charge and discharge operations of the battery pack if the tilt becomes less than the reference tilt after the charge and discharge operations of the battery pack are interrupted.

The electric bicycle may further include a reference tilt adjusting unit for adjusting the reference tilt according to a user's input. The electric bicycle may further include a driving control unit for interrupting operation of wheels of the electric bicycle after the charge and discharge operations are resumed by the sensing unit.

### BRIEF DESCRIPTION OF THE DRAWINGS

These and other aspects will become apparent and more readily appreciated from the following description of the embodiments, taken in conjunction with the accompanying drawings of which:

FIG. 1 is a block diagram of an electric bicycle according to an embodiment of the present invention;

FIG. 2 is a diagram for explaining a tilt angle according to an embodiment of the present invention;

FIG. 3 is a block diagram of an electric bicycle according to another embodiment of the present invention;

FIG. 4 is a block diagram of an electric bicycle according to another embodiment of the present invention;

FIG. 5 is a block diagram of a sensing/processing unit in FIG. 4, according to an embodiment of the present invention;

FIG. 6 is a flowchart of a battery pack protection method according to an embodiment of the present invention;

FIG. 7 is a flowchart of a battery pack protection method according to another embodiment of the present invention; and

FIG. 8 is a flowchart of a battery pack protection method according to another embodiment of the present invention.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

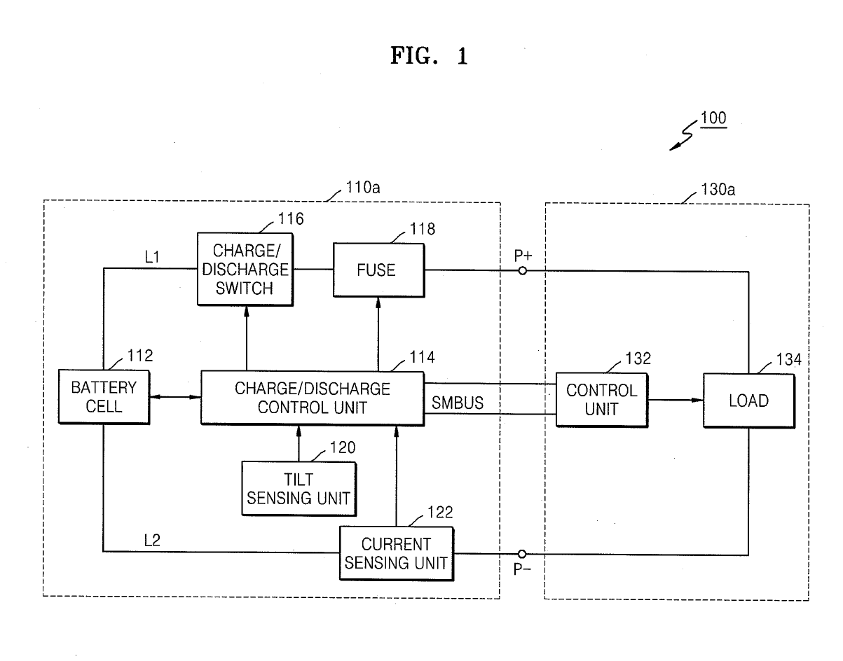

FIG. 1 is a block diagram of an electric bicycle 100 according to an embodiment of the present invention.

The electric bicycle 100 according to the present embodiment can include a battery pack 110a and a bicycle unit 130a as an external device connected to the battery pack 110a, wherein the battery pack 110a supplies electric energy to the external device 130a.

The battery pack 110 can include at least one battery cell unit 112, a charge/discharge control unit 114 that senses a voltage level of the battery cell unit 112 and performs a predetermined control operation, a charge/discharge switch 116 that blocks or opens a charge or discharge path according to the control operation of the charge/discharge control unit 114, a fuse 118 that may permanently block the charge/discharge path according to the control operation of the charge/discharge control unit 114, and a current sensing unit 122 that senses current in the charge/discharge path. In addition, the battery pack 110a can include a sensing unit 120 that senses variation in the angle of orientation of the battery pack 110a.

The battery cell unit 112 may be any battery, for example, a rechargeable lithium ion battery, a lithium polymer battery, or the like. An anode charge/discharge path L1 may be connected to an anode of the battery cell unit 112, and a cathode charge/discharge path L2 may be connected to a cathode of the battery cell unit 112. An anode charge/discharge terminal (P+) may be located at an end of the anode charge/discharge path L1, and a cathode charge/discharge terminal (P−) may be located at an end of the cathode charge/discharge path L2. The anode charge/discharge terminal (P+) and the cathode charge/discharge terminal (P−) may be connected to the bicycle unit 130a to transfer electric energy stored in the battery cell unit 112 to the bicycle unit 130a or to store electric energy generated by the bicycle unit 130a in the battery cell unit 112.

The charge/discharge control unit 114 may be connected to the battery cell unit 112 in parallel to sense the voltage level of the battery cell unit 112 and can output a control signal for controlling charge and discharge operations of the battery pack 110a according to the sensed voltage. To this end, the charge/discharge control unit 114 may measure voltage levels of a plurality of battery cells in the battery cell unit 112. The current sensing unit 122 can sense a current level in the cathode charge/discharge path L2 or the anode charge/discharge path L1. The charge/discharge control unit 114 can output a control signal for controlling charge and discharge operations of the battery pack 110a according to the voltage level sensed by the charge/discharge control unit 114 or the current level sensed by the current sensing unit 122. Furthermore, the charge/discharge control unit 114 may have functions, such as overcharge protection, over-discharge protection, and over-current protection. The charge/discharge control unit 114 may control the charge and discharge operations of the battery pack 110a according to a control signal received from the bicycle unit 130a or a user's input.

The charge/discharge control unit 114 may be connected to a control unit 132 that controls the operation of the bicycle unit 130a, via a system management bus SMBUS, including a clock signal line and a data signal line.

The sensing unit 120 can sense a variation in the angle of orientation of the battery pack 110a. To this end, the sensing unit 120 may include any type of sensor for sensing a variation in the angle of orientation or a “tilt” of the battery pack 110a.

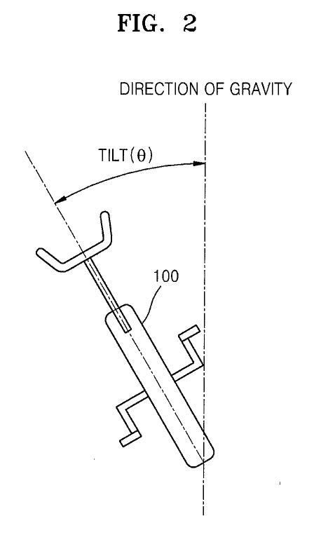

Throughout the specification the term “tilt” of the battery pack 110a refers to an angle of orientation (θ) of the electric bicycle 100 with respect to the direction of gravity, as illustrated in FIG. 2. However, the meaning of the “tilt” angle (θ) is not limited to this, and may be varied.

The charge/discharge control unit 114 can output a stop control signal for stopping the charge and discharge operations if the tilt of the battery pack 110a is greater than or equal to a predetermined angle of orientation or a reference tilt. The electric bicycle 100 mounted with the battery pack 100a may fall over during riding and thus the battery pack 110a may be damaged when dropped. The battery cell unit 112 of the battery pack 110a in the electric bicycle 100 may ignite or explode when damaged. In the present embodiment, the charge/discharge control unit 114 can interrupt the charge and discharge operations of the battery pack 110a when the tilt of the battery pack 110a is greater than or equal to the reference tilt, to prevent the transfer of electric energy between the battery pack 110a and the bicycle unit 130a in the event of a fall. Thus, the user and the battery pack 110a may be protected in the event that the electric bicycle 100 falls over, since the electric energy transfer to the bicycle unit 130a may be interrupted accordingly. Furthermore, the safety and reliability of the battery pack 110a are improved.

In addition, the charge/discharge control unit 114 may output a recovery control signal for resuming the charge and discharge operations of the battery pack 110a to the charge/discharge switch 116 when the tilt of the battery pack 110a becomes less than the reference tilt after the charge and discharge operations of the battery pack 110a are interrupted in response to the stop control signal. To this end, the sensing unit 120 can continue to sense the tilt of the battery pack 110a even after the charge and discharge operations of the battery pack 110a have been interrupted in response to the stop control signal. In general, the tilt of a bicycle may frequently vary. Thus, the battery pack 110a may resume the charge and discharge operations of the battery pack 110a if the tilt of the battery pack 110a becomes less than the reference tilt after the charge and discharge operations have been interrupted in response to the stop control signal. In the present embodiment, the charge and discharge operations of the battery pack 110a may be resumed without user intervention to quickly recover a normal operation of the electric bicycle 100. Thus, the user's convenience can improve.

The bicycle unit 130a can include the control unit 132 and a load 134. The bicycle unit 130a can control overall operation of the electric bicycle 100. The load 134 may be supplied with the electric energy from the battery pack 110a and provide power to the bicycle unit 103a.

In another embodiment of the present invention, the charge/discharge control unit 114 may interrupt the charge and discharge operations of the battery pack 110a only when the tilt angle of the battery pack 110a has been maintained greater than or equal to the reference tilt for a first reference time duration or longer, rather than interrupting the charge and discharge operations of the battery pack 110a immediately after the tilt angle is greater than or equal to the reference tilt. In addition, the charge/discharge control unit 114 may resume the charge and discharge operations of the battery pack 110a only when the tilt angle of the battery pack becomes less than the reference tilt within a second reference time duration from when the charge and discharge operations are interrupted in response to the stop control signal.

In general, the tilt angle of a bicycle may frequently vary. Thus, an increase in the tilt angle may likely be a momentary instance. Thus, the charge and discharge operations of the battery pack 110a may not be interrupted, even when the tilt angle is greater than or equal to the reference tilt, unless the tilt angle has been maintained greater than or equal to the reference tilt for a predetermined time duration, that is, the first reference time duration, or longer, in order to prevent excessive stopping of the charge and discharge operations.

To this end, the charge/discharge control unit 114 can measure time from when the sensing unit 120 senses that the tilt angle is greater than or equal to the reference tilt or measures time from when the charge and discharge operations of the battery pack 110a are interrupted in response to the stop control signal.

The charge/discharge control unit 114 can output the stop control signal to the charge/discharge switch 116 when the tilt angle sensed by the sensing unit 120 is greater or equal to the reference tilt or has been maintained greater than or equal to the reference tilt for the first reference time duration or longer. In addition, the charge/discharge control unit 114 can output the recovery control signal when the tilt angle of the battery pack 110a sensed by the sensing unit 120 becomes less than the reference tilt within the second reference time duration from when the charge and discharge operations are interrupted in response to the stop control signal.

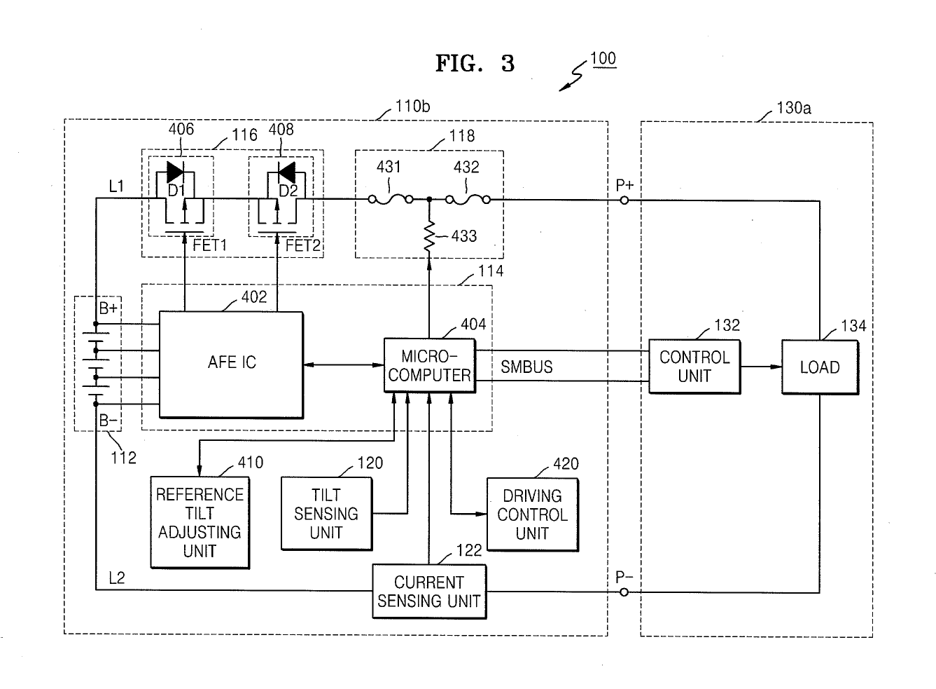

FIG. 3 is a block diagram of an electric bicycle 100 according to another embodiment of the present invention.

Referring to FIG. 3, a battery pack 110b of the electric bicycle 100 according to the illustrated embodiment further includes a reference tilt adjusting unit 410 that allows the user to adjust the reference tilt. The battery pack 110b can further include a driving control unit 420 that stops operations of the bicycle unit 130a when the tilt angle is greater than or equal to the reference tilt and thus the charge and discharge operations of a battery pack 110b may be interrupted.

The battery cell unit 112, the charge/discharge control unit 114, the charge/discharge switch 116 and the fuse 118 in FIG. 3 may have structures that will be described below. The structures described below are for illustrative purposes and do not limit the scope of the present invention.

According to an embodiment, the battery cell unit 112 may include a plurality of battery cells connected in series. The number of battery cells in the battery cell unit 112 may be varied according to the capacities of the battery pack 110b and each of the battery cells.

The change/discharge switch 116 can include a charging device 406 and a discharging device 408. The charging device 406 and the discharging device 508 may be connected in series between the anode charge/discharge terminal (P+) (or the cathode charge/discharge terminal (P−)) and the anode charge/discharge path L1 (or the cathode charge/discharge path L2) to charge or discharge the battery pack 110b. Each of the charging device 406 and the discharging device 408 can include a field effect transistor (FET) and a parasitic diode (D). In particular, the charging device 406 can include a field effect transistor FET1 and a parasitic diode D1. The discharging device 408 can include a field transistor FET2 and a parasitic diode D2.

According to an embodiment, the direction in which a source and a drain of the field effect transistor FET1 of the charging device 406 are connected on L1 is opposite to the direction in which those of the field effect transistor FET2 of the discharging device 408 are connected on L2. In other words, the field effect transistor FET1 of the charging device 406 may be connected to selectively restrict the flow of current from the anode or cathode charge/discharge terminal (P+ or P−) to the battery cell unit 112, and the field effect transistor FET2 of the discharging device 408 may be connected to selectively restrict a flow of current from the battery cell unit 112 to the anode or cathode charge/discharge terminal (P+ or P−). In this regard, the field effect transistor FET1 of the charging device 406 and the field effect transistor FET2 of the discharging device 408 may be switching devices. However, the field effect transistors FET1 and FET2 are not limited thereto and may be any electric device with a switching function.

The parasitic diode D1 of the charging device 406 and the parasitic diode D2 of the discharging device 408 may be arranged such that current flows in a direction opposite to a direction in which respective FETs thereof restrict the flow of current. When a current is supplied from the battery cell unit 112 into the bicycle unit 130a, the field effect transistor FET1 of the charging device 406 may be turned off and the field effect transistor FET2 of the discharging device 408 may be turned on. Thus, discharge current can flow through the parasitic diode D1 of the charging device 406 and the field effect transistor FET2 of the discharging device 408. On the contrary, when the battery cell unit 112 is charged by the bicycle unit 130a or a charger (not shown), the field effect transistor FET1 of the charging device 406 may be turned on and the field effect transistor FET2 of the discharging device 408 may be turned off. Thus, discharge current can flow through the parasitic diode D2 of the discharging device 408 and the field effect transistor FET1 of the charging device 408.

The charge/discharge control unit 114 can include an analog front-end integrated circuit (AFE IC) 402 and a microcomputer 404.

The AFE IC 402 may be connected in parallel to the battery cell unit 112, in parallel to the charging device 406 and the discharging device 408, and in series between the battery cell unit 112 and the microcomputer 404 described below. The AFE IC 402 can sense the voltage level of the battery cell unit 112, transmit the sensed voltage level to the microcomputer 404, and control operations of the charging device 406 and the discharging device 408 according to control of the microcomputer 404.

In particular, when a charge current is supplied to the battery cell unit 112 from the bicycle unit 130 or the charger, the AFE IC 112 can turn on the field effect transistor FET1 of the charging device 406 and turns off the field effect transistor FET2 of the discharging device 408, so that the battery cell unit 112 may be charged. Likewise, when the load 134 of the bicycle unit 130a is electrically connected to be supplied power from the battery cell unit 112, the AFE IC 112 can turn off the field effect transistor FET1 of the charging device 406 and turn on the field effect transistor FET2 of the discharging device 408, so that the battery cell unit 112 may discharge.

The microcomputer 404 may be an IC connected in series between the AFE IC 402 and the bicycle unit 130a. The microcomputer 404 can control the charging device 406 and the discharging device 408 via the AFE IC 420 to prevent the battery cell unit 112 from being overcharged or over-discharged, and from supplying or being supplied an over-current. In other words, the microcomputer 404 can compare the voltage level of the battery cell unit 112 received via the AFE IC 402 from the battery cell unit 112 with a voltage level set in the microcomputer 404 and output a control signal generated based on the result of the comparison to the AFE IC 402 so as to turn on or off the charging device 406 and the discharging device 408. As such, the microcomputer 404 may protect the battery cell unit 112 from being overcharged or over-discharged, and from supplying or being supplied an over-current.

In more particular detail, if the voltage level of the battery cell unit 112 is greater than or equal to an overcharge voltage level set in the microcomputer 404, for example, 4.35V, the microcomputer 404 can determine that the battery cell unit 112 is in an overcharged state and output a corresponding control signal to the AFE IC 402 to turn off the field effect transistor FET1 of the charging device 406. Then, the battery cell unit 112 may be blocked from being charged by the bicycle unit 130a or the charger. On the contrary, if the voltage level of the battery cell unit 112 is less than or equal to an over-discharge voltage level set in the microcomputer 404, for example, 2.30V, the microcomputer 404 can determine the battery cell unit 112 as being in an over-discharged state and output a corresponding control signal to the AFE IC 402 to turn off the field effect transistor FET2 of the discharging device 408. Then, the battery cell unit 112 may be blocked from being over-discharged by the load 134 of the bicycle unit 130a.

In addition, the microcomputer 404 can communicate with the bicycle unit 130a via the system management bus SMBUS. In other words, the microcomputer 404 can receive information about the battery cell unit 112, such as the voltage level of the battery cell unit 112, from the AFE IC 402 and transmit the information to the bicycle unit 130a. In this regard, the information about the battery cell unit 112 may be transmitted to the bicycle unit 130a through a data line in synchronization with a clock signal from a clock line in the system management bus SMBUS.

Furthermore, the microcomputer 404 can receive a signal indicating the tilt angle from the sensing unit 120 to control the charge and discharge operations of the battery package 110b according to the tilt angle of the electric bicycle 100.

The current sensing unit 122 may be any device for sensing current of the battery pack 110b. Information about the current sensed by the current sensing unit 170 can be provided to the microcomputer 404. If an over-current is flowing in the battery pack 110b, the microcomputer 404 can output a control signal for blocking the flow of current to turn off the charging device 406 and the discharging device 408 or the fuse 118. As such, the microcomputer 404 can protect the battery pack 110b from supplying or being supplied an over-current.

The fuse 118 can include two fuses 431 and 432 connected to the anode charge/discharge path L1 in series, and a heating resistor 433 connected to a contact point between the fuses 431 and the 432. If a current level sensed by the current sensing unit 122 is greater than or equal to a reference level, the thermal resistor 433 may be heated above a predetermined temperature according to the control of the microcomputer 404, so that at least one of the fuses 431 and 432 is burnt out, thereby completely blocking the anode charge/discharge path L1.

The reference tilt adjusting unit 410 can adjust the reference tilt used in interrupting the charge and discharge operations of the battery pack 110b. The reference tilt may be adjusted, for example, according to a user's input. The user may adjust the reference tilt according to his/her riding pattern. To this end, the reference tilt adjusting unit 410 may include an interface that allows the user to input a control signal.

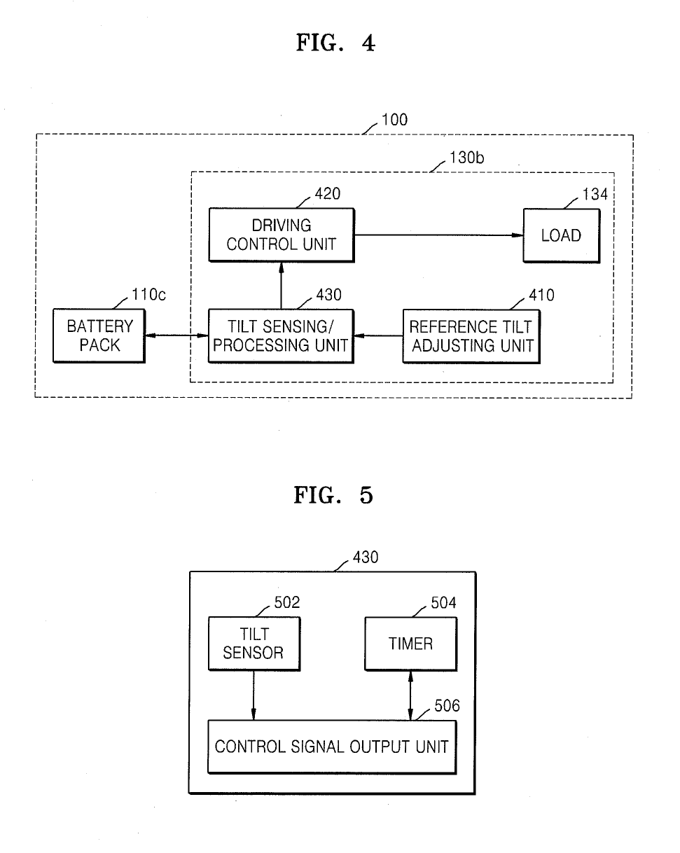

When the charge and discharge operations of the battery pack 110b are resumed in response to the recovery control signal, the driving control unit 420 can control the bicycle unit 130 to not operate for predetermined time duration or until a user's input is received. To this end, the driving control unit 420 may output a drive stop signal to the microcomputer 404. Then, the microcomputer 404 may output the drive stop signal to the control unit 132 of the bicycle unit 103a through the system management bus SMBUS to prevent wheels of the bicycle unit 103 from operating for a predetermined time duration. However, the driving control unit 420 is not limited to the structure illustrated in FIG. 4. For example, the driving control unit 420 may be installed in the microcomputer 404.

FIG. 4 is a block diagram of an electric bicycle 100 according to another embodiment of the present invention.

In the electric bicycle 100 according to the embodiment illustrated in FIG. 4, a bicycle unit 130b may include a sensing or processing unit 430, the reference tilt adjusting unit 410 and the driving control unit 420. A battery pack 110c may control the charge and discharge operations thereof according to the tilt (θ) of the electric bicycle 100 and according to the sensing/processing unit 430 in the bicycle unit 130b. In the illustrated embodiment, the bicycle unit 130b may generate a stop control signal and a recovery control signal and output the same to the battery pack 110c. Thus, with any type of battery pack mounted on the bicycle unit 130b, the charge and discharge operations of the battery pack 110c may be controlled according to the tilt angle of the electric bicycle 100. The battery pack 110c can interrupt the charge and discharge operations in response to the stop control signal output from the bicycle unit 130b and resume the charge and discharge operations in response to the recovery control signal output from the bicycle unit 130b.

FIG. 5 is a block diagram of the sensing/processing unit 430 in FIG. 4, according to an embodiment of the present invention.

Referring to FIG. 5, the sensing/processing unit 430 according to the illustrated embodiment includes a sensor 502 that senses a tilt angle, a timer 504 that measures time, and a control signal output unit 506 that outputs a stop control signal or a recovery control signal according to the tilt angle. The sensing/processing unit 430 does not interrupt the charge and discharge operations of the battery pack 110c immediately after the tilt angle is greater than or equal to the reference tilt, but only when the tilt angle has been maintained greater than or equal to the reference tilt for a first reference time duration or longer. In the illustrated embodiment, the charge and discharge operations of the battery pack 110c are resumed only when the tilt angle becomes less than the reference tilt within a second reference time duration from when the charge and discharge operations are interrupted.

The sensor 502 may sense the tilt angle of the electric bicycle 100. The sensor 502 may sense the tilt angle of the electric bicycle 100 mounted with the battery pack 110c with respect to the direction of gravity, as illustrated in FIG. 2.

The timer 504 can measure time from when the tilt angle sensed by the sensor 502 is greater than or equal to the reference tilt and measure time from when the charge and discharge operations of the battery pack 110c are interrupted in response to the stop control signal.

The control signal output unit 506 can output the stop control signal to the battery pack 110c when the tilt angle sensed by the sensor 502 is greater than or equal to the reference tilt or has been maintained greater than or equal to the reference tilt for the first reference time duration or longer. In addition, the control signal output unit 506 can output a recovery control signal to the battery pack 110c when the tilt angle of the battery pack 110a sensed by the sensor 502 becomes less than the reference tilt within the second reference time duration from when the charge and discharge operations are interrupted in response to the stop control signal.

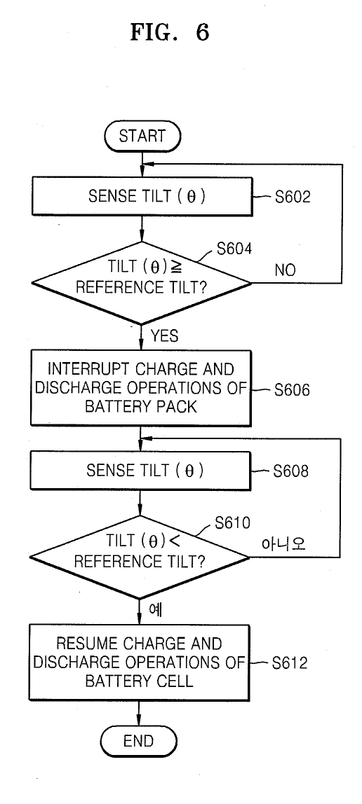

FIG. 6 is a flowchart of a method of protecting a battery pack, according to an embodiment of the present invention.

First, a tilt angle of an electric bicycle mounted with a battery pack is sensed (Operation S602). The tilt angle refers to a variation in the angle of orientation of the electric bicycle with respect to the direction of gravity, as illustrated in FIG. 2.

If the tilt angle is greater than or equal to a reference tilt (Operation S604), charge and discharge operations of the battery pack can be interrupted (Operation S606). To this end, all switching devices of a charging device and a discharging device in the battery pack may be controlled to be turned off.

If the tilt angle is less than the reference tilt (Operation S604), the tilt angle of the electric bicycle can be sensed again (Operation S602).

Once the charge and discharge operations of the battery pack are interrupted, sensing of the tilt angle of the electric bicycle can be continued (Operation S608). If the tilt angle is less than the reference tilt (Operation S610), the charge and discharge operations of the battery pack can be resumed (Operation S612).

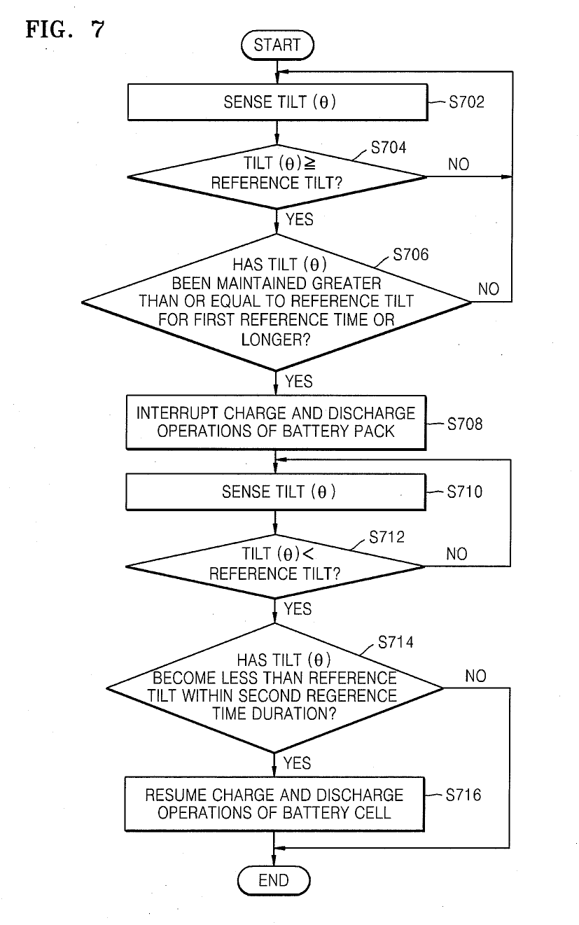

FIG. 7 is a flowchart of a method of protecting a battery pack, according to another embodiment of the present invention.

In the illustrated embodiment, charge and discharge operations of a battery pack are interrupted only when a tilt angle of an electric bicycle has been maintained greater than or equal to a reference tilt for a first reference time duration or longer. In addition, the charge and discharge operations of the battery pack may be resumed only when the tilt angle of the electric bicycle becomes less than the reference tilt within a second reference time duration.

First, the tilt angle of the electric bicycle is sensed (Operation S702), and it is determined whether the tilt angle is greater than or equal to the reference tilt.

If the tilt angle is greater than or equal to the reference tilt (Operation S704), it is determined whether the tilt angle has been maintained greater than or equal to the reference tilt for a first reference time duration or longer (Operation S706). In this regard, any type of timer may be used to measure the time that the tilt angle is maintained greater than or equal to the reference tilt.

If the tilt angle has been maintained greater than or equal to the reference tilt for the first reference time duration or longer (Operation S706), the charge and discharge operations of the battery pack may be interrupted (Operation S708). However, if the tilt angle becomes less than the reference tilt before the first reference time duration has passed, the tilt angle of the electric bicycle is sensed again (S702), without stopping the charge and discharge operations of the battery pack.

Once the charge and discharge operations of the battery pack have been interrupted (Operation S708), sensing of the tilt angle of the electric bicycle may be continued (Operation S710), and it would be determined whether the tilt angle is less than the reference tilt (Operation S712). If the tilt angle is less than the reference tilt, it would be determined whether the tilt angle becomes less than the reference tilt within a second reference time duration (Operation S714). If the tilt angle does not become less than the reference tilt within the second reference time duration, the charge and discharge operations can remain interrupted and controlling the charge and discharge operations be stopped. If the tilt angle becomes less than the reference tilt within the second reference time duration, the charge and discharge operations of the battery pack can be resumed (Operation S716).

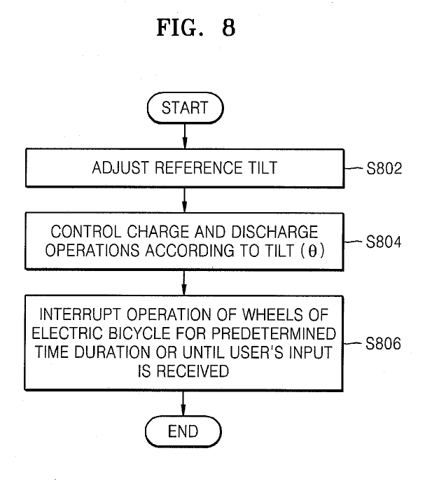

FIG. 8 is a flowchart of a method of protecting a battery pack, according to another embodiment of the present invention.

In the method of protecting a battery pack, according to the illustrated embodiment, the user may be allowed to adjust a reference tilt. In addition, operation of wheels of the electric bicycle may be interrupted for predetermined time duration from when the charge and discharge operations of the battery pack resume.

Referring to FIG. 8, the user may adjust a reference tilt (Operation S802), the reference tilt being used to determine whether to interrupt the charge and discharge operations of the battery pack, wherein the charge and discharge operations of battery pack may be interrupted if a tilt angle of the electric bicycle is greater than or equal to the reference tilt. Operation 802 may be performed at any time, and is not limited to as ordered illustrated in FIG. 8. The user may input a control signal for adjusting the reference tilt through an interface loaded on the electric bicycle.

Next, the charge and discharge operations of the battery pack may be controlled according to the tilt angle of the electric bicycle (Operation S804). The controlling of the charge and discharge operations of the battery pack according to the tilt angle of the electric bicycle may involve Operations S602 through S612 or S702 through S716 described above with reference to FIGS. 6 and 7.

Once the interrupted charge and discharge operations of the battery pack resume because the tilt angle of the electric bicycle is less than the reference voltage (Operation S612 or S716), the operation of the wheels of the electric bicycle may be interrupted for a predetermined time duration or until a user's input is received (Operation S806).

As described above, according to the one or more of the above embodiments of the present invention, charge and discharge operations of a battery pack may be controlled according to a tilt of the battery pack or a tilt of an electric bicycle mounted with the battery pack. Thus, damage of the battery package may be prevented, and the risk of explosion may be reduced.

It should be understood that the embodiments described herein should be considered in a descriptive sense only and not for purposes of limitation. Descriptions of features or aspects within each embodiment should typically be considered as available for other similar features or aspects in other embodiments.

What is claimed is:

1. A battery pack protection circuit comprising:
a sensing unit for sensing a variation in an angle of orientation;
a charge/discharge control unit for outputting a stop control signal for interrupting charge and discharge operations of a battery cell, if the angle of orientation is greater than or equal to a reference angle of orientation; and
a charge/discharge switch for stopping the charge and discharge operations of the battery cell in response to the stop control signal.

2. The battery pack protection circuit of claim 1, wherein the charge/discharge control unit outputs a recovery control signal for resuming the charge and discharge operations of the battery cell to the charge/discharge switch when the angle of orientation becomes less than the reference angle of orientation after the stop control signal is output.

3. The battery package protection circuit of claim 1, wherein the charge/discharge control unit outputs the stop control signal only when the angle of orientation has been maintained greater than or equal to the reference angle of orientation for a first reference time duration or longer.

4. The battery pack protection circuit of claim 3, wherein the charge/discharge control unit outputs a recovery control signal for resuming the charge and discharge operations of the battery cell to the charge/discharge switch when the angle of orientation becomes less than the reference angle of orientation within a second reference time duration from when the stop control signal is output, and
the charge/discharge switch resumes the charge and discharge operations of the battery cell in response to the recovery control signal.

5. The battery pack protection circuit of claim 1, further comprising a reference angle of orientation adjusting unit for adjusting the reference angle of orientation according to a user's input.

6. The battery pack protection circuit of claim 2, wherein the battery pack protection circuit is used in a battery pack for an electric bicycle, wherein the battery pack protection circuit further comprises a driving control unit for outputting a drive control signal for stopping operation of wheels of the electric bicycle after the recovery control signal has been output.

7. A battery pack protection method comprising:
sensing a tilt;
determining whether the tilt is greater than or equal to a reference tilt; and
interrupting charge and discharge operations of a battery cell if the tilt is greater than or equal to a reference tilt.

8. The battery pack protection method of claim 7, further comprising resuming the charge and discharge operations of the battery cell if the tilt becomes less than the reference tilt after a stop control signal is output.

9. The battery pack protection method of claim 7, wherein the interrupting of the charge and discharge operation is performed only when the tilt has been maintained greater than or equal to the reference tilt for a first reference time duration or longer.

10. The battery pack protection method of claim 8, further comprising determining whether the tilt becomes less than the reference tilt within a second reference time duration from when the stop control, signal is output, and resuming the charge and discharge operations of the battery cell is performed only when the tilt becomes less than the reference tilt within the second reference time duration from when the stop control signal is output.

11. The battery pack protection method of claim 7, further comprising adjusting the reference tilt according to a user's input.

12. The battery pack protection method of claim 8, wherein the battery pack protection method is used in a battery pack for an electric bicycle, and wherein the method further comprises interrupting operation of wheels of the electric bicycle after a recovery control signal is output.

13. An electric bicycle on which a battery pack is mountable, the electric bicycle comprising a sensing unit for sensing a tilt of the electric bicycle and interrupting the charge and discharge operations of the battery pack if the tilt is greater than or equal to a reference tilt.

14. The electric bicycle of claim 13, wherein the sensing unit resumes the charge and discharge operations of the battery pack if the tilt becomes less than the reference tilt after the charge and discharge operations of the battery pack are interrupted.

15. The electric bicycle of claim 13, wherein the sensing unit interrupts the charge and discharge operations of the battery pack only when the tilt has been maintained greater than or equal to the reference tilt for a first reference time duration or longer.

16. The electric bicycle of claim 15, wherein the sensing unit resumes the charge and discharge operations of the battery pack if the tilt becomes less than the reference tilt after the charge and discharge operations of the battery pack are interrupted.

17. The electric bicycle of claim 13, further comprising a reference tilt adjusting unit for adjusting the reference tilt according to a user's input.

18. The electric bicycle of claim 14, further comprising a driving control unit for interrupting operation of wheels of the electric bicycle after the charge and discharge operations are resumed by the sensing unit.
